(19) United States
(12) Patent Application Publication
(10) Pub. No.: US 2012/0073937 A1
(43) Pub. Date: Mar. 29, 2012

(54) MEDIUM CONVEYOR APPARATUS AND CONTROL METHOD

(76) Inventors: Kiminori Toya, Kawasaki-shi (JP); Hideki Nukada, Yokohama-shi (JP); Yuko Kobayashi, Kawasaki-shi (JP)

(21) Appl. No.: 13/040,362

(22) Filed: Mar. 4, 2011

(30) Foreign Application Priority Data
Sep. 27, 2010 (JP) 2010-215837

(51) Int. Cl. B65G 69/20; B65G 43/00; B65G 35/00

(52) U.S. Cl. 198/617; 198/631.1

(57) ABSTRACT

According to one embodiment, a medium convey apparatus is provided with an oscillation unit, a cooling unit, a convey unit, a temperature detector and a controller. The oscillation unit applies oscillation to a thin medium as a to-be-conveyed target. The cooling unit cools the air around the thin medium. The convey unit conveys the thin medium. The temperature detector detects the temperature around the medium. The controller controls the cooling unit based on the temperature detected by the temperature detector.

### CROSS-REFERENCE TO RELATED APPLICATIONS

This application is based upon and claims the benefit of priority from Japanese Patent Application No. 2010-215837, filed Sep. 27, 2010; the entire contents of which are incorporated herein by reference.

### FIELD

Embodiments described herein relate generally to a medium conveyor apparatus and a control method for conveying thin mediums.

### BACKGROUND

A technique of reducing, using high-frequency oscillation, the frictional force exerted on a medium conveyed by a conveyor mechanism is known.

As an example, there is a technique of reducing frictional forces that will occur in a pickup mechanism for picking up stacked sheets one by one, which technique is employed in a power saving apparatus for dealing with mediums in the form of sheets, such as securities. In this technique, the pressing force of an oscillator is controlled when a sheet medium is oscillated with high frequency, thereby reducing the frictional force that occurs between an uppermost sheet and a subsequent sheet stacked just below the former.

As another example, there is a technique of reducing the sliding resistance between a web and a conveyor mechanism, employed in a web conveyor apparatus, such as a film producing apparatus, for dealing with a continuous sheet medium. In this technique, the sliding resistance is reduced by controlling the state of contact between the conveyor mechanism and the web.

There is a demand for techniques of further reducing the frictional force that exerts on a thin medium conveyed by a conveyor mechanism.

### BRIEF DESCRIPTION OF THE DRAWINGS

FIG. 1 is a view illustrating a structure example of a medium conveyor apparatus according to a first embodiment;

FIG. 2 is a flowchart useful in explaining an operation example of medium conveyor apparatuses employed in first to fourth embodiments;

FIG. 3 is a view illustrating a structure example of a medium conveyor apparatus according to a second embodiment;

FIG. 4 is a view illustrating a structure example of an injection nozzle;

FIG. 5 is a view illustrating another structure example of the medium conveyor apparatus according to the second embodiment;

FIG. 6 is a view illustrating a structure example of a medium conveyor apparatus according to a third embodiment;

FIG. 7 is a view illustrating a structure example of a medium conveyor apparatus according to a fourth embodiment;

FIG. 8 is a view useful in explaining the outline of a frictional force measuring experiment;

FIG. 9 is another view useful in explaining the outline of the frictional force measuring experiment;

FIGS. 10A, 10B and 10C show the results of experiments in which a thick sheet of paper is used and the frictional force reduction effect of oscillation is detected to increase as the temperature decreases;

FIGS. 11A, 11B and 11C show the results of experiments in which an SUS plate is used, and in a low humidity state, the frictional force reduction effect of oscillation is detected to increase as the temperature decreases; and

FIGS. 12A, 12B and 12C show the results of experiments in which the SUS plate is used, and in a high humidity state, the frictional force reduction effect of oscillation is detected to increase as the temperature decreases.

### DETAILED DESCRIPTION

Referring to the accompanying drawings, medium conveyor apparatuses according to the embodiments of the invention will be described in detail. In the embodiments, like reference numbers denote like elements, and no duplicate explanations will be given.

In general, according to one embodiment, a medium convey apparatus is provided with an oscillation unit, a cooling unit, a convey unit, a temperature detector and a controller. The oscillation unit applies oscillation to a thin medium as a to-be-conveyed target. The cooling unit cools the air around the thin medium. The convey unit conveys the thin medium. The temperature detector detects the temperature around the medium. The controller controls the cooling unit based on the temperature detected by the temperature detector.

In the description below, the “thin medium” includes, for example, a rectangular thin medium, and a very narrow and long medium. The former indicates a medium that is not continuous, such as mail items, securities and steel plates, and will be hereinafter also referred to as the “non-continuous thin medium.” The latter indicates a medium that is continuous, such as a web of paper or film, and will be hereinafter also referred to as the “continuous thin medium.” The non-continuous thin medium is not limited to a rectangular one, and the continuous thin medium is not limited to a linear one. Further, the material of the thin mediums is not limited to paper or plastic, but may be, for example, metal.

Firstly, a description will be given of the frictional force exerted on a thin medium (to-be-conveyed medium) in an apparatus for conveying the medium.

There is no document that sufficiently explains the mechanism for reducing the frictional force in the medium convey apparatus, using high-frequency oscillation. Therefore, the inventors of the present invention have firstly analyzed the mechanism.

The mechanism for reducing the frictional force by high-frequency oscillation will be explained from the state of air that oscillates where the frictional force occurs. For example, in an apparatus for conveying, one by one, sheets of paper stacked on each other, there is a problem of a frictional force that occurs between a firstly conveyed sheet and a subsequent one. It is considered that the frictional force is influenced by the state of air that exists between those sheets. Further, in a web conveyor apparatus, the frictional force is considered to be influenced by the state of air that exists between a turn bar and a web of a medium.

When the layer of air is very thin, the air will mainly oscillate along the surface of a to-be-conveyed medium (hereinafter, simply referred to as a “convey medium or sheet”). In general, when a fluid oscillates at high frequency in a certain area, it is known that the pressure of the fluid in the area increases because of a nonlinear effect. Accordingly, in the above-mentioned apparatus, it is expected that the pressure of the air increases to change the contact state of the medium to thereby reduce the frictional force.

The behavior of the air is modeled by the following equations (1) to (3). The equation (1) is a fluid equation, the equation (2) expresses the continuous state of the fluid (air), and the equation (3) is a state equation that expresses the state of air presumably subjected to adiabatic change.

$$\begin{matrix}{ρ}_{a} \frac{\partial }{\partial t} v + {ρ}_{a} ( v \cdot grad ) v = - {gradP}_{a} & ( 1 ) \\ \frac{\partial }{\partial t} {ρ}_{a} + div ( {ρ}_{a} v ) = 0 & ( 2 ) \\ P = ρ {c}^{2} & ( 3 )\end{matrix}$$

where ρa is the density of the fluid (air), v is the velocity of the fluid, Pa is the pressure of the fluid, and c is the acoustic velocity.

The stationary term of each physical property, and the first order term and second order term of each physical property will now be considered. For example, regarding the pressure Pa, the atmospheric pressure P₀ is considered as the stationary term, and the linear and perturbation components P₁ and P₂ are considered as the first order and second order terms, and Pa is expressed as Pa=P₀+P₁+P₂. Similarly, the density ρa and the velocity v are expressed as ρa=ρ₀+ρ₁+ρ₂ and v=v₀+v₁+v₂, respectively.

Second-order approximation of the equations (1) and (2) is performed, and the equation (3) is combined with the resultants, thereby acquiring the following equations (4) and (5):

$$\begin{matrix}{ρ}_{0} \frac{\partial }{\partial t} {v}_{2} + {gradP}_{2} = - \frac{{P}_{1}}{{c}^{2}} \frac{\partial }{\partial t} {v}_{1} - {ρ}_{0} ( {v}_{1} \cdot grad ) {v}_{1} & ( 4 ) \\ \frac{\partial }{\partial t} {P}_{2} + {c}^{2} {ρ}_{0} div ( {v}_{2} ) = - div ( {P}_{1} {v}_{1} ) & ( 5 )\end{matrix}$$

Further, general equations (6) and (7) expressing forced oscillation are combined with each of the equations (4) and (5), and the terms that contain no time stationary terms and no harmonics are extracted, with the result that the following equations (8) and (9):

$$\begin{matrix}{v}_{1 ( r , t )} = \frac{1}{2} ( {v}_{1 ( r , ω )} {e}^{- i ω t} + {v}_{1 ( r , - ω )} {e}^{i ω t} ) & ( 6 ) \\ {P}_{1 ( r , t )} = \frac{1}{2} ( {P}_{1 ( r , ω )} {e}^{- i ω t} + {P}_{1 ( r , - ω )} {e}^{i ω t} ) & ( 7 ) \\ {gradP}_{2} = \frac{i ω}{4 {c}^{2}} ( {P}_{1 ( r , - ω )} {v}_{1 ( r , ω )} - {P}_{1 ( r , ω )} {v}_{1 ( r , - ω )} ) - \frac{{ρ}_{0}}{4 } ( ( {v}_{1 ( r , - ω )} \cdot grad ) {v}_{1 ( r , ω )} + ( {v}_{1 ( r , ω )} \cdot grad ) {v}_{1 ( r - ω )} ) & ( 8 ) \\ {c}^{2} {ρ}_{0} div ( {v}_{2} ) = - \frac{1}{4} div ( {P}_{1 ( r , - ω )} {v}_{1 ( r , ω )} + {P}_{1 ( r , ω )} {v}_{1 ( r , - ω )} ) & ( 9 )\end{matrix}$$

where r represents the plane coordinates parallel to the surface of each sheet with the center of applied oscillation set to zero.

The equations (8) and (9) are combined to solve P₂, whereby the following equation (10) is acquired:

$$- Δ {P}_{2} = \frac{{ω}^{2} {ρ}_{0}}{2 {c}^{2}} [ \frac{1}{{c}^{2} {ρ}_{0}^{2}} {P}_{1 ( r , ω )} {P}_{1 ( r , - ω )} - \frac{3}{2} {v}_{1 ( r , ω )} \cdot {v}_{1 ( r , - ω )} ] \qquad ( 10 )$$

If the equation (10) is regarded as a Poisson equation, the following equation (11) can be obtained as a solution.

$${P}_{2 ( r )} = \frac{{ω}^{2} {ρ}_{0}}{2 {c}^{2}} \frac{1}{4 π} \int \frac{1}{\vert r - {r}^{′} \vert} [ \frac{1}{{c}^{2} {ρ}_{0}^{2}} {P}_{1 ( {r}^{′} , ω )} {P}_{1 ( {r}^{′} , - ω )} - \frac{3}{2} {v}_{1 ( {r}^{′} , ω )} \cdot {v}_{1 ( {r}^{′} , - ω )} ] d {r}^{′} \qquad ( 11 )$$

From the equation (11), it can be understood that the pressure increase P₂ of the air layer due to the nonlinear effect is inversely proportional to c₂. Since the acoustic velocity c is substantially proportional to the square root of the absolute temperature, P₂ is inversely proportional to the ambient absolute temperature. As P₂ increases, the sheet is raised to change the contact state of the sheets. Accordingly, it is considered that as the temperature decreases, the frictional force reduction effect by high-frequency oscillation is accelerated.

The inventors of the present invention have confirmed as a result of experiments that the ambient temperature of a convey medium influences the frictional force reduction effect of high-frequency oscillation.

FIG. 8 is a view useful in explaining experiments of measuring the frictional force between stacked sheets.

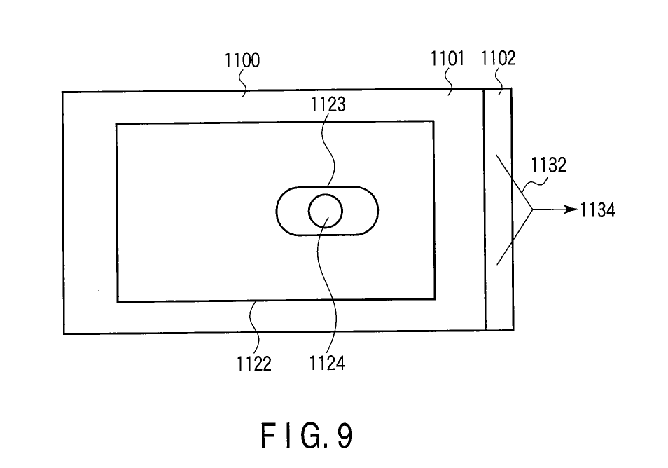

In this experiment, stacked sheets 1100 of a paper medium are placed on a table 1120, and a weight 1122, which serve as loads, and an oscillator 1124 are placed on the top sheet 1101. As shown in FIG. 9, the weight 1122 has an opening 1123, through which the oscillator 1124 is brought into contact with the top sheet 1101. Three sheets 1100 are stacked on the table 1120 such that a measurement target sheet 1102 is held between two sheets 1101 and 1103 substantially fixed in position. The measurement target sheet 1102 is coupled to a load meter 1130 by a wire 1132 that is hard to expand, and the load meter 1130 is mounted on a moving mechanism (not shown). If the load meter 1130 is moved in the direction indicated by arrow 1134 by pulling the moving mechanism in the same direction, the measurement target sheet 1102 is also moved in the direction (namely, the sheet 1102 is pulled by the wire 1132).

In the experiments, the pulling force, which is required to pull the measurement target sheet 1102 as the above and indicated by the load meter 1130, is recorded as the above-mentioned frictional force.

The frictional force, which occurs when the weight 1122 is placed and no oscillator 1124 is placed, is compared with the frictional force which occurs when both the weight 1122 and the oscillator 1124 are placed, thereby measuring the frictional force reduction effect of the oscillator 1124.

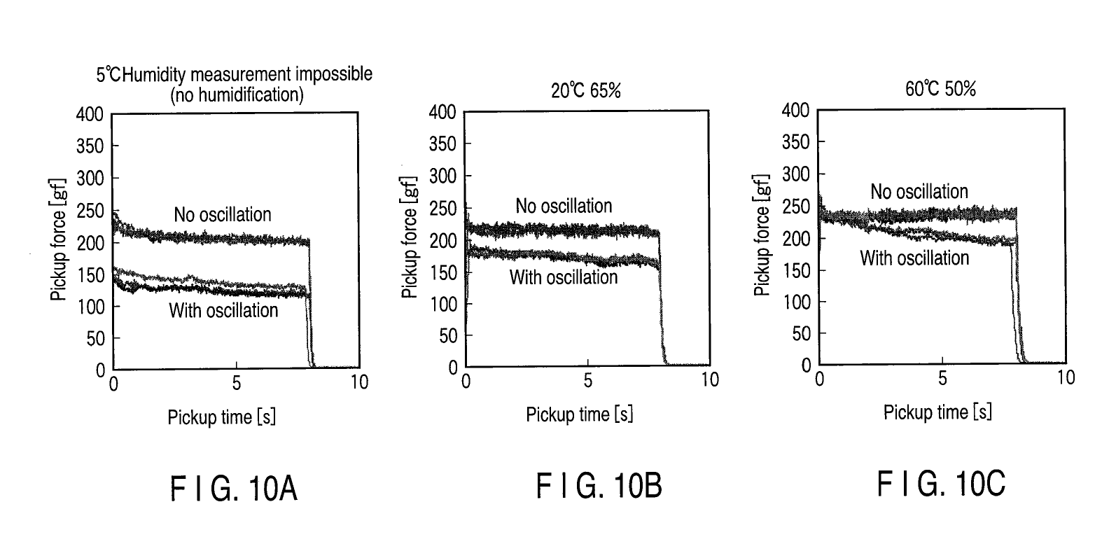

In the initial experiments, paper sheets (so-called cardboards) having a size of 100 mm×148 mm, a thickness of 0.2 mm and a weight of 100 g were used, the pulling speed was set to 5 mm/s, and the frictional force was measured for 8 seconds. FIGS. 10A to 10C show the measurement results obtained with the ambient temperature varied. FIGS. 10A to 10C show the cases where the ambient temperature was set to 5° C., 20° C. and 60° C., respectively, and each show three frictional force measurement results. (Note that in the case of FIG. 10A, no humidity could be measured (no humidity was applied), in the case of FIG. 10B, the humidity was set to 65%, and in the case of FIG. 10C, the humidity was set to 50%.) It is evident from the measurement results that the frictional force is more significantly reduced by oscillation as the temperature is lower.

Subsequently, to eliminate the influence of humidity (cardboards are influenced by humidity), the same experiments were performed using SUS plates having a size of 100 mm×148 mm and a thickness of 0.2 mm were used.

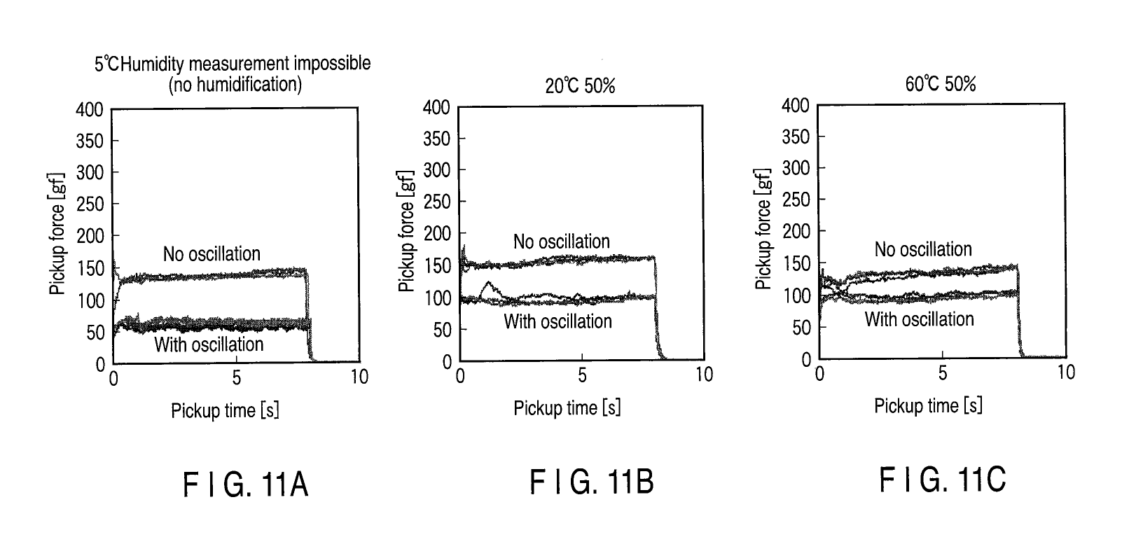

FIGS. 11A to 11C show the measurement results obtained in a dry state with a humidity of 50%, with the ambient temperature varied. FIGS. 11A to 11C show the cases where the ambient temperature was set to 5° C., 20° C. and 60° C., respectively, and each show three frictional force measurement results. (Note that in the case of FIG. 11A, no humidity could be measured (no humidity was applied).)

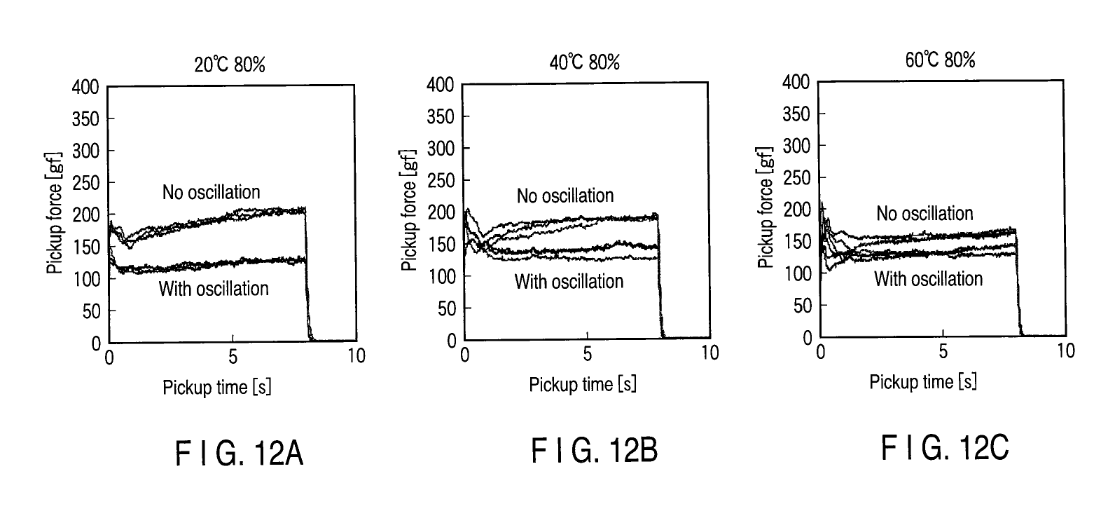

FIGS. 12A to 12C show the measurement results obtained in a humidified state with a humidity of 80% or more, with the ambient temperature varied. FIGS. 12A to 12C show the cases where the ambient temperature was set to 20° C., 40° C. and 60° C., respectively, and each show three frictional force measurement results. (Note that since humidity adjustment could not be performed at 5° C., measurement was executed at 40° C.)

As is evident from FIGS. 11A to 11C and FIGS. 12A to 12C, the lower the temperature, the greater the frictional force reduction under oscillation.

The experimental results and the analysis by the inventors of the present invention indicate that the frictional force exerted on the convey sheet is more reduced by high-frequency oscillation at low temperature. From this, it is apparently effective to reduce the ambient temperature of sheets in order to increase the frictional force reduction effect of high-frequency oscillation.

On the other hand, when mediums are cooled, they may be frozen or dew condensation may occur on them. In view of this, it is necessary to control temperature reduction in accordance with the types of the mediums. To this end, the embodiments described below employ a mechanism for monitoring the ambient temperature of each medium or the temperature of each medium itself to control the temperature.

The embodiments described below have a basic structure comprising an oscillation unit for applying oscillation to a thin medium as a convey target, a cooling unit for cooling the air around the thin medium, a convey unit for conveying the thin medium, a temperature detector for detecting the ambient temperature of the thin medium, and a controller for controlling the cooling unit based on the detected temperature.

The embodiments can increase the frictional force reduction effect of high-frequency oscillation (within a range in which the state of a medium is adversely affected).

The embodiments will now be described in detail.

### First Embodiment

A first embodiment will be described.

The first embodiment is directed to a medium conveyor apparatus for conveying non-continuous thin mediums.

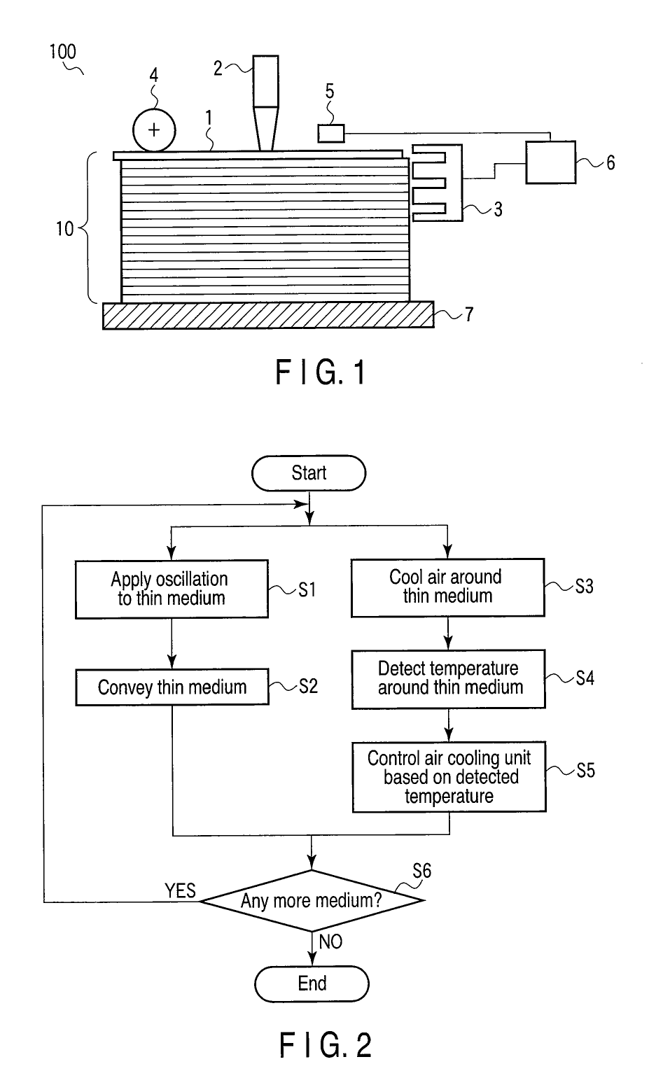

FIG. 1 shows a structure example of a medium conveyor apparatus 100 according to a first embodiment.

As shown in FIG. 1, the medium conveyor apparatus 100 comprises an oscillator 2 for oscillating an uppermost sheet 1 serving as a convey target and included in stacked thin sheets (hereinafter, the stacked sheets) 10; an air cooling unit 3 for cooling the air around sheets and between them; a conveyor unit 4 serving as a conveyor mechanism for applying a convey force to the uppermost sheet 1 of the stacked sheets 10; a temperature detector 5 for detecting the temperature around the uppermost sheet 1; and a controller 6 for controlling the output of the air cooling unit 3 in accordance with the detection result of the temperature detector 5. In FIG. 1, reference number 7 denotes a mount table.

The stacked sheets 10 may be securities as thin sheets of paper, steel plates, plastic plates, etc.

The medium conveyor apparatus 100 has a function of picking up each sheet at preset timing and forwarding the same to a processing unit (not shown).

The medium conveyor apparatus 100 may be part of, for example, a mail processing apparatus.

The stacked sheets 10 are placed on the mount table 7. It is desirable that after the uppermost sheet 1 of the stacked sheets 10 is conveyed, the mount table 7 be raised to set the subsequent sheet as a new uppermost sheet in the same condition as the previous uppermost sheet 1.

In order to convey the uppermost sheet 1, the medium conveyor apparatus 100 separates the sheet 1 from the subsequent sheet positioned just below the former. At this time, in the first embodiment, high-frequency oscillation is applied to the sheet 1 and the temperature of the sheet and the temperature around the same are reduced.

The oscillator 2 is an oscillator for oscillating the sheet 1 by high frequency radiation. Specifically, a BLT oscillator, a laminated metal magnetic distortion oscillator, a n-type ferrite oscillator, etc., can be used as the oscillator 2. When the oscillator 2 oscillates the sheet 1, the air between the sheet 1 and the subsequent sheet below the same oscillates to thereby reduce the frictional force therebetween.

The air cooling unit 3 is a mechanism for cooling the air around the sheet 1 and the air between adjacent sheets (and also, the oscillator). More specifically, a heat exchanger comprising, for example, a Peltier device and a compressor may be used as the air cooling unit 3. In the structure of FIG. 1, the air cooling unit 3 may be provided around the stacked sheets 10 to cool the air of the sheet 1, the air around the sheet 1, and the air between sheets. However, the arrangement of the air cooling unit 3 is not limited to this. The air cooling unit 3 is controlled by the controller 6.

The conveyor unit 4 is a machine for picking up the sheet 1. The conveyor unit 4 may be formed of a general pickup machine, such as a rubber roller, a suction-type rotor and a suction-type belt.

The temperature detector 5 is a machine for measuring the temperature of the sheet 1 or the temperature around the sheet 1. The temperature detector 5 may be formed of a general thermometer such as a thermocouple and a noncontact thermometer. The temperature measured by the temperature detector 5 is input to the controller 6. The temperature detector 5 may detect temperature at various places. For instance, the detector 5 may be installed to detect the temperature of the oscillator 2, of the fixed portion of the same, of the contact portion of the oscillator 2 and the sheet 1, or of the air, near the sheet 1.

The controller 6 controls the output of the air cooling unit 3. The controller 6 executes control, using, for example, a general control algorithm, to set the temperature of or around the sheet 1 to a predetermined value. There is no particular limitation to the control algorithm. An optimal temperature may be beforehand determined and set in the controller as the predetermined value. For instance, if the medium is a sheet of copy paper, it is preferable to control the temperature of the medium to approx. 5° C. so as to prevent ice or frost from occurring on the surface thereof to thereby adversely affect its printing performance.

FIG. 2 is an example of a flowchart useful in explaining the operation of the medium conveyor apparatus according to first through fourth embodiments.

In this example, when a thin medium as a convey target exists (step S6), an oscillation is applied thereto (step S1), whereby the thin medium is conveyed (step S2). During this process, the air around the thin medium is cooled (step S3), and the temperature around the thin medium is detected (step S4) to control the air cooling unit based on the detected temperature (step S5).

Oscillation may be always applied to the thin medium, or may be applied thereto for predetermined periods before and after the pickup operation.

Further, the output of the air cooling unit may be changed at predetermined timing associated with the pickup operation of the thin medium, or be changed regardless of the pickup operation of the thin medium.

The flowchart of FIG. 2 is merely an example, and other operations can be employed.

In the first embodiment, since high-frequency oscillation is applied and the ambient temperature of the thin medium is reduced during the pickup operation, the frictional force exerted on the picked thin medium can be further reduced.

### Second Embodiment

A description will be given of a second embodiment, in particular, of the elements different from those of the first embodiment.

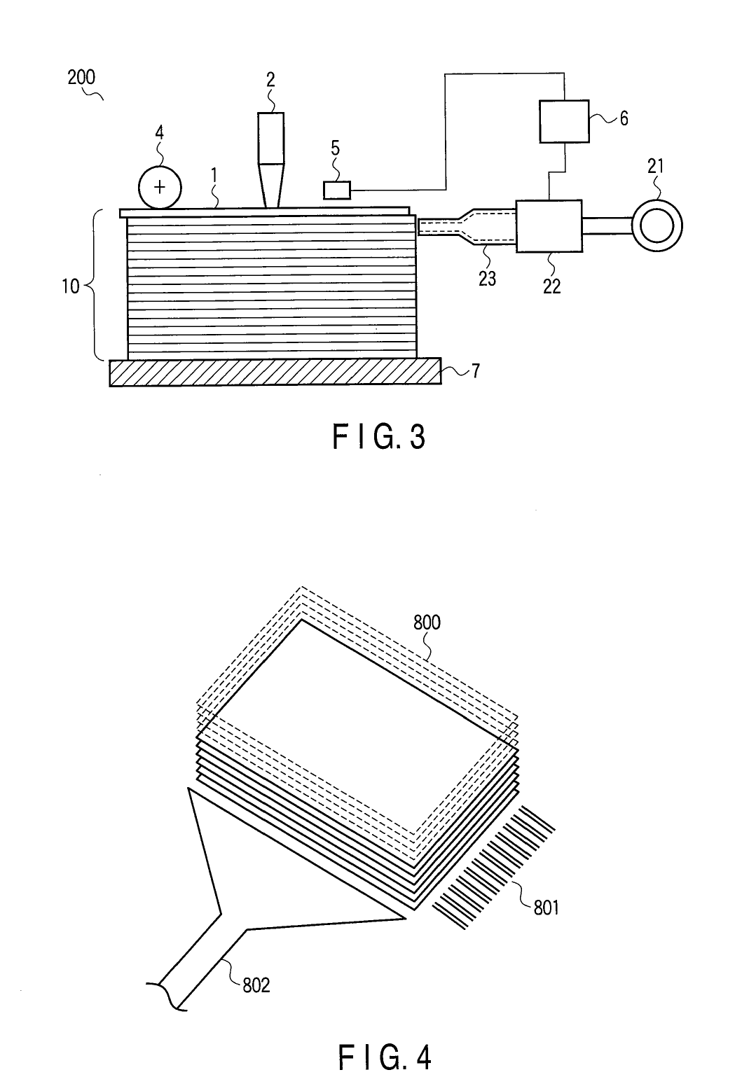

FIG. 3 shows a structure example of a medium convey apparatus 200 according to the second embodiment.

As shown in FIG. 3, the medium convey apparatus 200 employs a machine for cooling the air around a sheet of a medium or the air between sheets of the medium, which machine comprises, in place of the air cooling unit 3 of FIG. 1 (first embodiment), an air compressing unit 21 for compressing air, and an air cooling unit 22 for cooling the air compressed by the air compressing unit, and an injection nozzle unit 23 for injecting the compressed air to the medium (or the medium and an oscillator). The other structure of this apparatus is similar to that shown in FIG. 1.

The air compressing unit 21 is a machine having a function of compressing air using, for example, a compressor, and supplying the compressed air to the air cooling unit 22.

The air cooling unit 22 cools the air compressed by the air compressing unit 21, and supplies the cooled air to the injection nozzle unit 23.

The injection nozzle unit 23 is a machine provided near the sheet 1 for blowing cooled air to the sheet 1. The injection nozzle unit 23 has a function of cooling the air between sheets, and also has a function of separating an adhered sheet so that it can be used as a sheet handling machine.

FIG. 4 shows an arrangement example of the injection nozzle unit.

In FIG. 4, reference number 800 denotes a stack of sheets (of, for example, paper), reference number 801 denotes general injection nozzles arranged along the entire width of sheets, and reference number 802 denotes a wide cooling-air introduction nozzle.

To efficiently cool the air around the medium, the injection nozzles 801 may be arranged along the entire width of the medium, or the wide cooling-air introduction nozzle 802 having a width corresponding to the entire width of the medium may be arranged along the entire width of the medium.

Further, the injection nozzles 801 or the wide cooling-air introduction nozzle 802 may be arranged along every side of the stacked sheets 800.

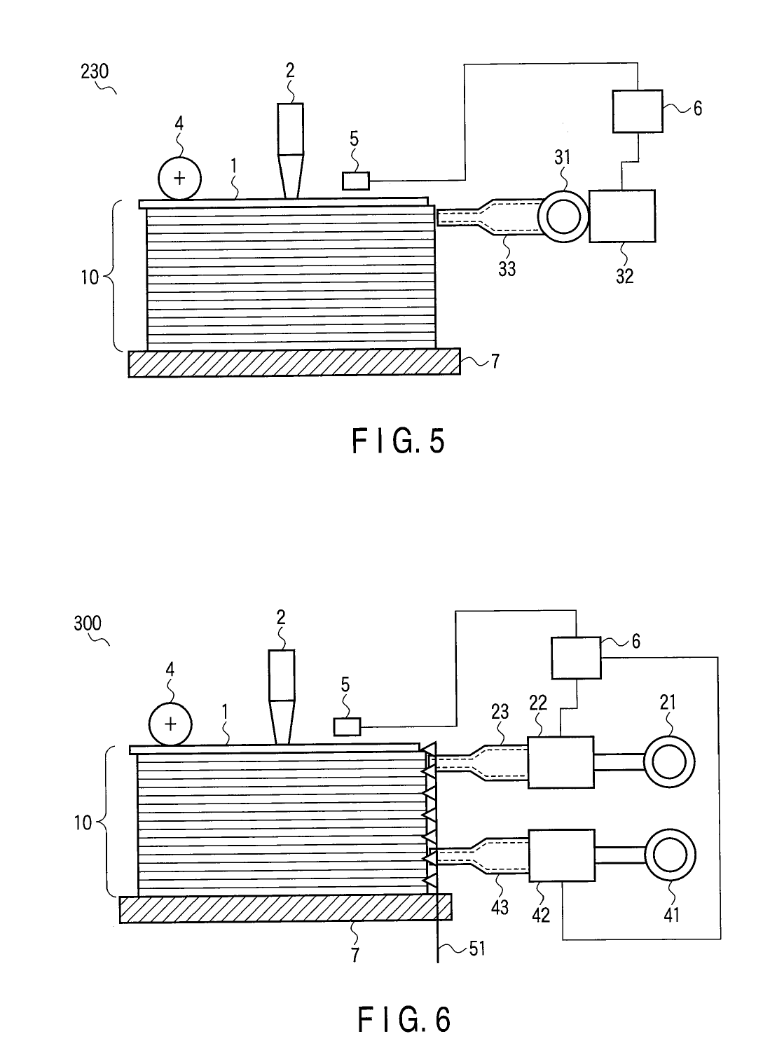

FIG. 5 shows another structure example 230 of the medium convey apparatus of the second embodiment.

In the medium convey apparatus 230 of FIG. 5, the order of air compression and air cooling is opposite to that in the structure of FIG. 3. More specifically, the medium convey apparatus 230 comprises an air cooling unit 32 for cooling air, an air compressing unit 31 for compressing the air cooled by the air cooling unit 23, and an injection nozzle unit 33 for injecting the compressed air to the medium (or the medium and an oscillator). The other structure of this apparatus is similar to those shown in FIGS. 1 and 3.

### Third Embodiment

A description will be given of a third embodiment, in particular, of the elements different from those of the first and second embodiments.

FIG. 6 shows a structure example of a medium convey apparatus 300 according to the third embodiment.

As shown in FIG. 6, the medium convey apparatus 300 employs a structure, in addition to the structure of FIG. 3 (the second embodiment), for dehumidifying a medium, which comprises an air compressing unit 41 for compressing air, an air dehumidifying unit 42 for dehumidifying the air compressed by the air compressing unit 41, and an injection nozzle unit 43 for injecting the dehumidified compressed air to the medium. The medium convey apparatus 300 may also employ a sheet riffling unit 51. The other structure of this apparatus is similar to those shown in FIGS. 1, 3 and 5.

If the sheet 1 is a sheet of paper, it is desirable to prevent dew concentration thereon during cooling. To this end, it is desirable to beforehand dehumidify the sheets 10 stacked on the mount table 7.

The air dehumidifying unit 42 has a function of dehumidifying the air blown into the injection nozzle unit located below the cooling-air injection nozzle unit 23. A known dehumidifying mechanism utilizing condensation reheating is used to realize the dehumidifying function.

If the mount table 7 is raised whenever a pickup operation is completed, each sheet mounted on the table 7 is moved upwardly, which means that it is subjected firstly to dehumidification and then to cooling.

The sheet riffling unit 51 is a machine for riffling one end of each of the stacked sheets to facilitate introduction of the dehumidified air and the cooled air into spaces between the sheets. More specifically, the riffling unit 51 may employ a conventional technique of vertically sliding a belt along the ends of the stacked sheets to produce spaces between the ends of the sheets.

The structure of FIG. 6 is obtained by adding, to the structure of FIG. 3, a unit for dehumidifying the medium (or the sheet riffling unit as well as the humidifying unit). A structure, which is obtained by adding the dehumidifying unit (or the sheet riffling unit as well as the humidifying unit) of FIG. 6 to the structure of FIG. 5, may also be employed. Yet further, this structure of the structure of FIG. 6 may include an air dehumidifying unit for dehumidifying air, an air compressing unit for compressing the dehumidified air, and an injection nozzle unit for injecting the dehumidified and compressed air to the medium, instead of the air compressing unit 41, the air dehumidifying unit 42, and the injection nozzle unit 43 of FIG. 6.

### Fourth Embodiment

A description will be given of a fourth embodiment, in particular, of the elements different from those of the first to third embodiments.

The fourth embodiment is directed to a medium convey apparatus 400 for conveying a thin continuous medium.

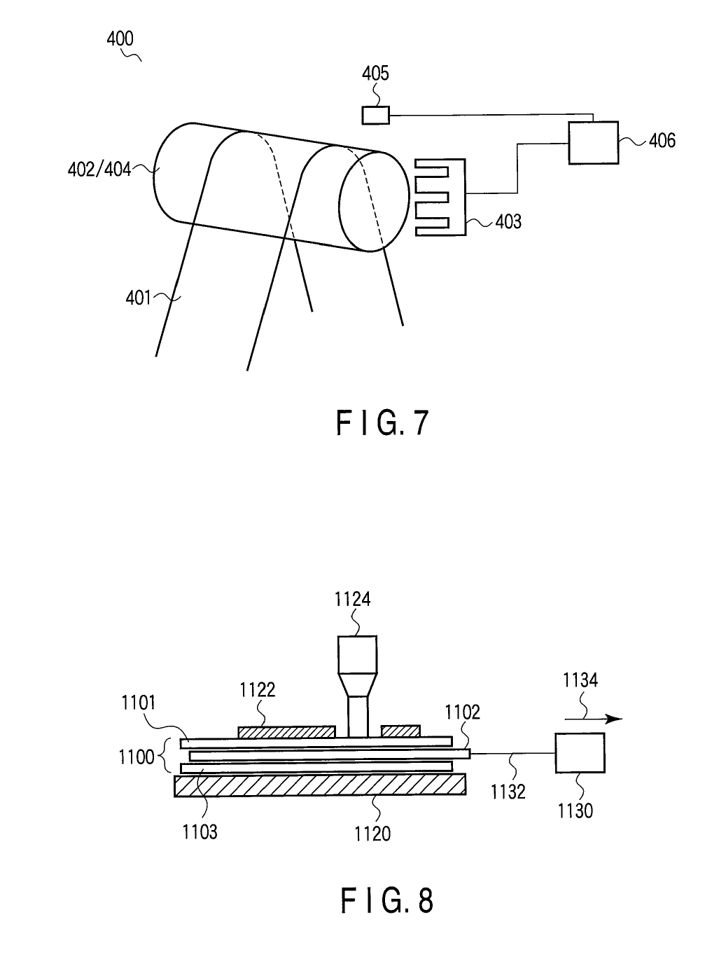

FIG. 7 shows a structure example of the medium convey apparatus 400 according to the fourth embodiment.

As shown in FIG. 7, the medium convey apparatus 400 comprises an oscillator 402 for oscillating a web 401 of a medium as a convey target, an air cooling unit 403 for cooling the air around the web, a conveyor unit 404 supporting the conveyance of the web 401, a temperature detector 405 for monitoring the ambient temperature of the web, and a controller 406 for controlling the output of the air cooling unit 403 based on the detection result of the temperature detector 405.

The web 401 may be paper web or film web, as aforementioned.

The oscillator 402 has a structure in which its surface wound by the web 401 is made to oscillate, and may be a known oscillator.

The air cooling unit 403 cools the periphery of the web 401.

The conveyor unit 404 conveys the web 401 when rotating with the web wound thereon (it also serves to change the convey direction of the web 401). The surface of the convey unit 404 is configured to oscillate, and hence the conveyor unit 404 also functions as the oscillator 402.

The temperature detector 405 measures the temperature around the web 401 and the temperature of the oscillator 402, and outputs measurement results to the controller 406. The controller 406 has a function of adjusting the output of the air cooling unit 403 to set the temperature around the web 401 to a predetermined value.

In the example of FIG. 7, the oscillator 402 and the convey unit 404 are realized by the same structure. However, these units may be formed separately so that the oscillator 402 applies oscillation to the convey unit 404.

The cooling control mechanisms shown in FIGS. 3, 5 and 6 may be applied to the web convey apparatus.

Although in the above-described embodiments, mechanisms for conveying sheets of paper and a web of paper or film are described as examples, the embodiments can be also applicable to other mechanisms for conveying mediums with the frictional force reduced by high-frequency oscillation. As the other mechanisms, a wafer convey mechanism, a high-frequency linear slider mechanism, etc., can be pointed out. In these cases, the oscillator and the convey unit may be formed integral as one body, as in the fourth embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A medium convey apparatus comprising:
an oscillation unit configured to apply oscillation to a thin medium as a to-be-conveyed target;
a cooling unit configured to cool air around the thin medium;
a convey unit configured to convey the thin medium;
a temperature detector configured to detect a temperature around the medium; and
a controller configured to control the cooling unit based on the temperature detected by the temperature detector.

2. The apparatus according to claim 1, wherein
the cooling unit is an air cooling unit; and
the controller controls an output of the air cooling unit based on the temperature detected by the temperature detector.

3. The apparatus according to claim 1, wherein
the cooling unit includes:
an air compression unit configured to compress air;
an air cooling unit configured to cool the air compressed by the air compression unit; and
an injection nozzle configured to inject to the thin medium the compressed air cooled by the air cooling unit, and
the controller controls an output of the air cooling unit based on the temperature detected by the temperature detector.

4. The apparatus according to claim 1, wherein
the cooling unit includes:
an air cooling unit configured to cool air;
an air compression unit configured to compress the air cooled by the air cooling unit; and
an injection nozzle configured to inject to the thin medium the cooled air compressed by the air compression unit, and
the controller controls an output of the air cooling unit based on the temperature detected by the temperature detector.

5. The apparatus according to claim 1, wherein the controller configured to control an output of the air cooling unit based on the temperature detected by the temperature detector, such that the temperature around the thin medium is adjusted to a predetermined value.

6. The apparatus according to claim 1, wherein the convey unit picks up and conveys, one by one, sheets of the thin medium stacked on each other.

7. The apparatus according to claim 6, further comprising a medium riffling unit configured to riffle ends of the stacked sheets to define spaces between the ends.

8. The apparatus according to claim 1, wherein the convey unit rotates with a web of the thin medium wound thereon, to convey the thin medium.

9. A control method for use in a medium convey apparatus comprising:
applying oscillation to a thin medium as a to-be-conveyed target;
cooling air around the thin medium;
conveying the thin medium;
detecting a temperature around the thin medium; and
controlling the cooling based on the detected temperature.
